(19) United States
(12) Patent Application Publication
(10) Pub. No.: US 2008/0191535 A1
(43) Pub. Date: Aug. 14, 2008

(54) Locking Device in a Vehicle, In Particular For a Motor Vehicle Seat

(76) Inventors: Carsten Baumchen, Oberthal (DE); Peter Muller, Mackenbach (DE); Thomas Christoffel, Herschweiler-Pettersheim (DE)

Correspondence Address: MCGLEW & TUTTLE, PC, P.O. BOX 9227, SCARBOROUGH STATION, SCARBOROUGH, NY, 10510-9227, US

(21) Appl. No.: 11/911,757

(22) PCT Filed: Jun. 28, 2006
(86) PCT No.: PCT/EP2006/006232

§ 371 Date: Oct. 17, 2007

(30) Foreign Application Priority Data
Jul. 27, 2005 (DE) 10 2005 035 036.4

(51) Int. Cl. B60N 2/20; E05B 65/19

(52) U.S. Cl. 297/367; 70/240

(57) ABSTRACT

A locking device (1) in a vehicle, in particular for a vehicle seat, is provided with a base plate (3) which has a receptacle (5) for a counter element (B). At least one clamping eccentric (11) is mounted pivotably on the base plate (3) by means of a first bearing pin (9) and normally, on account of prestressing, secures the counter element (B) in the receptacle (5). At least one intercepting component (21) is likewise mounted pivotably on the base plate (3) and, in the event of a crash, leads to the counter element (B) being supported. The clamping eccentric (11) and the intercepting component (21) act directly on the counter element (B).

### CROSS REFERENCE TO RELATED APPLICATIONS

This application is a United States National Phase application of International Application PCT/EP2006/006232 and claims the benefit of priority under 35 U.S.C. §119 of German Patent Application 10 2005 035 036.4 filed Jul. 27, 2005, the entire contents of which are incorporated herein by reference.

### FIELD OF THE INVENTION

The present invention pertains to a locking device in a vehicle, in particular for a vehicle seat, for cooperating with a counter element, with a base plate, at least one clamping eccentric that is pivotably mounted on the base plate by means of a first bearing pin and that, in the normal case, through being pretensioned, secures the counter element, and with at least one intercepting component that is also pivotably mounted on the base plate and that in the event of a crash supports the counter element.

### BACKGROUND OF THE INVENTION

In the case of locking devices that are known as rotary latch locking devices, a pivotable pawl, the so-called rotary latch, is provided that cooperates directly with the counter element, by positively engaging therewith, and it is secured by a locking piece that acts on the pawl, approximately tangentially to the pivoting direction thereof. DE 101 15 667 describes a locking device of the type described above that has a pawl for directly cooperating with the counter element, said pawl normally being secured by the pretensioned clamping eccentric and, in the event of a crash, by the supporting intercepting component. The locking device is typically used for detachably fastening the entire vehicle seat to the floor of the vehicle, or for detachably locking the backrest of the vehicle seat to the bodywork or other parts of the vehicle structure.

### SUMMARY OF THE INVENTION

The invention is based on the object to simplify a locking device of the aforementioned type.

According to the invention, a locking device is provided in a vehicle, in particular for a vehicle seat, for cooperating with a counter element. The locking device comprises a base plate, at least one clamping eccentric that is pivotably mounted on the base plate by means of a first bearing pin and that, in the normal case, through being pretensioned, secures the counter element, and at least one intercepting component. The intercepting component is also pivotably mounted on the base plate. In the event of a vehicle crash the intercepting component supports the counter element. In the locked state of the locking device the clamping eccentric and the intercepting component act directly on the counter element as securing elements.

Because the clamping eccentric and the intercepting component act directly on the counter element, a structurally simplified locking device is provided that requires fewer components and is thus cheaper to manufacture, yet which is nevertheless free of play, crash-proof and simple to install. The device may be made of metal or—and this is particularly cost-effective—it can be made of plastic, in which case various components can be formed as a single piece. The clamping eccentric and the intercepting component can also be made in one piece, regardless of the material, i.e. behind one another in the direction of pivoting, as disclosed for example in DE 44 39 644 A1, so that they come into action depending on the angular position relative to the counter element.

The locking device according to the invention could be used, for example, in locks for pivot bearings, seat cushion locks, locks between the backrest and the substructure, for example when the backrest is folded in the table position, locks between the backrest and the vehicle structure, for example locks for load-through openings, locks between the seat cushion and the backrest and between the vehicle seat and the vehicle structure, or locks on covers and flaps, also outside a vehicle seat. The locking device is mounted on one of two components of the vehicle, in particular the vehicle seat, and the counter element is mounted on the other component, the two components being joined in the locked state by the cooperative interaction between the locking device and the counter element, and in the unlocked state being moveable relative to each other and/or moveable away from each other.

The base plate may have a receptacle for cooperating positively with the counter element. If the receptacle is appropriately designed, preferably with a reinforcement, and if it is also suitably arranged, some of the forces can be absorbed by the base plate, in particular in the case of a crash. The remaining forces are normally absorbed by the clamping eccentric, up to the amount by which it is pretensioned, and for this purpose the clamping eccentric is normally directly in contact with the counter element, preferably via a curved clamping surface arranged eccentrically to the first bearing pin. Any excess forces are absorbed by the intercepting component, for which purpose the latter preferably directly supports the counter element in the event of a crash by means of an intercepting surface running or arranged tangentially or concentrically to the bearing pin of the intercepting component.

The clamping eccentric and the intercepting component may be mounted on the same bearing pin or on different bearing pins and they may be provided singly or in pairs, in order to absorb higher loads. When the securing elements are provided in pairs, they are preferably arranged and function in mirror-inverted symmetry to one another. For simple unlocking, an unlocking pin is preferably provided that is arranged on the intercepting component in order, first of all, to pivot the latter and then to take the clamping eccentric with it. The unlocking pin can also be provided on the clamping eccentric in order, with a delay in time, to take the intercepting component with it. When securing elements are provided in pairs, the unlocking pins are moved simultaneously and in opposite directions. The unlocking pin does not have to have the exact shape of a pin but may also be designed as a clip, ring, or similar. In principle, it would be conceivable to have the clamping eccentric cooperate in self-locking fashion with the counter element so that unlocking would be accomplished by moving the clamping eccentric. The intercepting component could then be dispensed with, unless it is to be used to provide support in the event of a crash.

In a preferred exemplary embodiment, a blocking element is provided that directly or indirectly holds at least one securing element open when the locking device is unlocked. As a result, the locking device is prevented from changing to an apparently locked state when the counter element is removed. This is important for the purpose of verifying the security status, which can be based on the position of a securing element and, if necessary, can also be rendered visible. In the unlocked state, the blocking element preferably directly holds just one securing element open, while it holds the other securing elements indirectly open, for example by means of couplings between the securing elements.

The blocking element cooperates preferably positively with the securing element which is to be kept open, in particular by having a shoulder section for cooperating with a corner or similar on the securing element. It is enough, however, that the blocking element and the securing element bear against each other within the self-locking arrangement, so that the various pretensionings cannot cause any movement of the securing element. The cooperation is preferably directly ended by the counter element, which happens when, with the locking device in the unlocked state, the blocking element crosses the receptacle transversely to the direction in which the counter element is inserted into the receptacle, so that when the counter element is inserted, it can force the blocking element aside and thus move it away from the securing element.

In the following, the invention is described in more detail on the basis of four exemplary embodiments, with modifications, as illustrated in the drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a partially sectional top view of the first exemplary embodiment according to the invention, the view being taken in the direction of the arrow I in FIG. 3;

FIG. 2 is a perspective view of the first exemplary embodiment according to the invention;

FIG. 3 is a lateral partially sectional view of the first exemplary embodiment according to the invention, the view being taken in the direction of the arrow III in FIG. 1;

FIG. 4 is a top view of the second exemplary embodiment according to the invention;

FIG. 5 is a partially sectional top view of the third exemplary embodiment according to the invention;

FIG. 6 is a partly cutaway view of the fourth exemplary embodiment according to the invention, shown in the locked state;

FIG. 7 is a view corresponding to FIG. 6, but shown in the unlocked state;

FIG. 8 is an exploded view of the fourth exemplary embodiment according to the invention;

FIG. 9 is a partly cutaway view of a modification of the fourth exemplary embodiment according to the invention, shown in the locked state; and

FIG. 10 is a view corresponding to FIG. 9, but shown in the unlocked state.

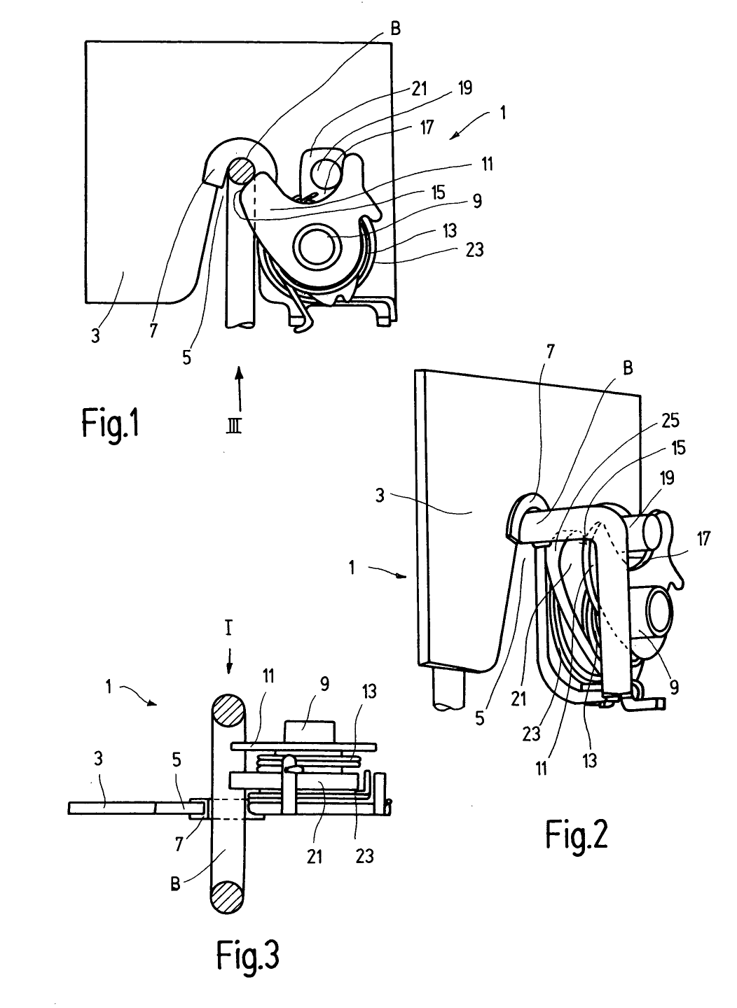

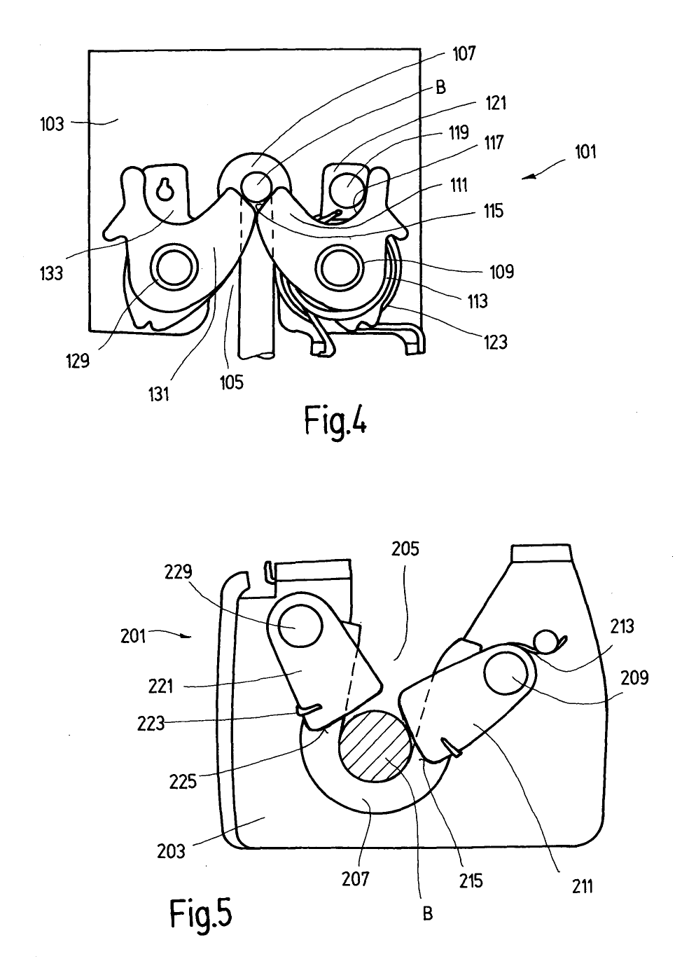

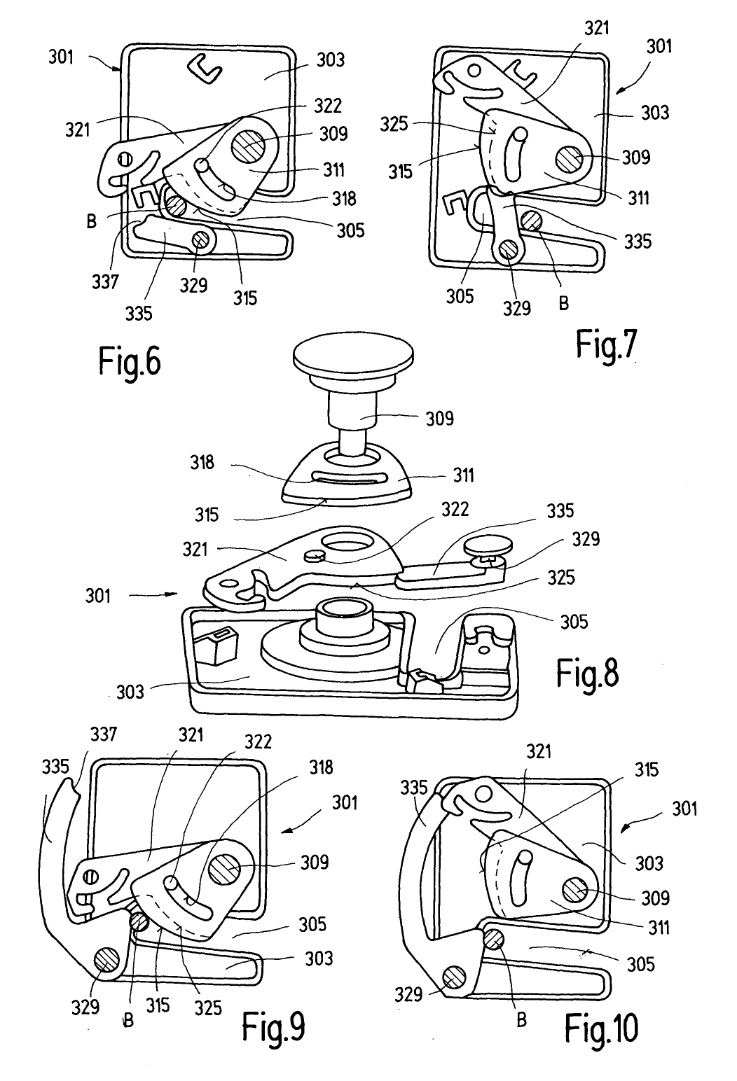

### DESCRIPTION OF THE PREFERRED EMBODIMENTS

Referring to the drawings in particular, in the first exemplary embodiment a locking device is designated by the reference number 1 wherein a vehicle seat for a motor vehicle has the locking device 1 for connecting two components. The locking device 1 is attached to the first component and cooperates with a counter element B that is attached to the second component. One of the components can also be assigned to the vehicle structure of the motor vehicle. The counter element B may have any desired profile, but is preferably cylindrical and has, for example, the form of a pin or U-shaped element. When the locking device 1 is not cooperating with the counter element B, i.e. the unlocked state exists, both components can be moved relative to each other, for example, they may be pivoted and/or moved away from each other. In the following, the locking device 1 is initially described in the locked state.

The locking device 1 comprises a base plate 3 that may be part of a housing or of the structure. The base plate 3 has a receptacle 5 that opens in the plane of the base plate 3 and, at its bottom section, which is provided with a reinforcement 7, the receptacle engages positively with the counter element B. A bearing pin 9 is arranged on the base plate 3 laterally from one flank of the receptacle 5; it protrudes from the base plate 3, to which in the present case it is fastened, in a direction parallel to the counter element B. A clamping eccentric 11 is mounted on the base plate 3 by means of the bearing pin 9 and is pivotable relative to the latter such that its pivoting range, which is oriented parallel to the base plate 3, passes over the receptacle 5. The clamping eccentric 11 is pretensioned against the counter element B located in the receptacle 5 by means of a first spring 13 that is supported on the base plate 3 and coiled around the bearing pin 9. The clamping surface 15 of the clamping eccentric 11 that bears against the counter element B is eccentrically curved relative to the bearing pin 9, so that the counter element B is forced into the receptacle 5 and is thus secured, in the normal case. The clamping surface 15 is adjoined by a fork of the clamping eccentric 11 and within said fork there is arranged an unlocking pin 19 oriented parallel to the bearing pin 9.

The unlocking pin 19 is mounted on an intercepting component 21 that is also mounted pivotably relative to the base plate 3 on the bearing pin 9. The intercepting component 21 is arranged along the bearing pin 9 between the clamping eccentric 11 and the base plate 3 and is pivotable in a plane parallel thereto, and its pivoting range also passes over the receptacle 5. The intercepting component 21 is pretensioned in the same direction as the clamping eccentric 11 by means of a second spring 23 supported on the base plate 3 and coiled around the bearing pin 9, and in the event of a crash it supports the counter element B so that the latter remains in the receptacle 5, even if the counter element B exerts an opening force on the clamping eccentric 11. The intercepting surface 25 of the intercepting component 21 that then bears against the counter element B is arranged tangentially or concentrically to the bearing pin 9, so that the counter element B cannot exert an opening force on the intercepting component 21.

To make the transition to the unlocked state of the locking device 1, the intercepting component 21 is pivoted back by means of the unlocking pin 19, and the clamping eccentric 11 is carried along by the unlocking pin 19 as it bears against the fork 17. The counter element B can now leave the receptacle 5. The locking device is now unlocked. The spring loading of the clamping eccentric 11 and of the intercepting component 21 brings these two securing elements 11 and 21 into a position in which they cross the receptacle 5, and a stop may be provided to limit travel. If the counter element B is re-inserted into the receptacle 5, the counter element B pushes the two securing elements 11 and 21 slightly back against their spring loading, so that they can become active again when the counter element B comes to bear against the reinforcement 7.

As regards structure and functionality, the locking device 101 of the second exemplary embodiment resembles the locking device of the first exemplary embodiment, unless otherwise described in the following, for which reason identical and identically functioning components bear reference numbers that are raised by 100. The base plate 103 together with the receptacle 105 that has the reinforcement 107 is the same as that of the first exemplary embodiment. A first bearing pin 109 and a first clamping eccentric 111 pivotably mounted thereon and pretensioned by a first spring 113, and a first intercepting component 121, also pivotably mounted on the first bearing pin 109 and pretensioned by a second spring 123, are the same as the corresponding components of the first exemplary embodiment, also as regards the configuration with clamping surface 115, fork 117, unlocking pin 119 and intercepting surface 125.

The direction in which the counter element B is inserted into the receptacle 105 and the line normal to the base plate 103 define a plane E. A second bearing pin 129, a second clamping eccentric 131 pivotably mounted thereon and a second intercepting component 133, also pivotably mounted on the second bearing pin 129, are configured and arranged with mirror-inverted symmetry—with reference to the plane E—to the first bearing pin 109, the first clamping eccentric 111 and the first intercepting component 121, which also pivot in the opposite direction to their mirror-inverted counterparts. The counter element B is thus held in the locked position from both sides. In order to unlock it, the two intercepting components 121 and 133 are pivoted in opposite directions by a toggle lever arrangement, whereupon the clamping eccentrics 111 and 131 pivot correspondingly in opposite directions in order to release the counter element B.

In a modified design, two clamping eccentrics and one intercepting component, or one clamping eccentric and two intercepting components may be provided.

The locking device 201 of the third exemplary embodiment is again similar in structure and functionality to the locking device of the first exemplary embodiment, unless otherwise described in the following, for which reason identical and identically functioning components have been assigned reference numbers raised by 200. The base plate 203 with the receptacle 205 having the reinforcement 207 corresponds to that of the first exemplary embodiment. A first bearing pin 209 and a clamping eccentric 211 pretensioned by a first spring 213 and pivotably mounted on said bearing pin, and an intercepting component 221 pretensioned by a second spring 223, correspond to the components of the first exemplary embodiment, also as regards the configuration with a clamping surface 215 and an intercepting surface 225. However, the intercepting component 221 is pivotably mounted, and is pretensioned in the opposite direction to the clamping eccentric 211, on a second bearing pin 229, arranged in approximately mirror-inverted symmetry to the first bearing pin 209, with reference to a plane E defined by the direction in which the counter element B is inserted and by the line normal to the base plate 203.

In the fourth exemplary embodiment, a vehicle seat for a motor vehicle has a locking device 301 for connecting two components, said locking device again being the same as that of the first exemplary embodiment with regard to structure and functionality, unless otherwise described below, for which reason identical and identically functioning components have been given reference numbers raised by 300. The locking device 301 is attached to the first component and cooperates with a counter element B that is attached to the second component. One of the components may also be assigned to the structure of the motor vehicle. The counter element B may have any desired profile, but is preferably cylindrical and, for example, may be a pin or a U-shaped element. If the locking device 301 is not cooperating with the counter element B, i.e. the unlocked state exists, both components can be moved, for example pivoted, relative to each other and/or they can be moved apart from each other. In the following, the locking device 301 is described initially in the locked state.

The locking device 301 comprises a base plate 303, which can be part of a housing or of the structure. The base plate 303 has a receptacle 305 that opens in a direction of insertion in the plane of the base plate 303, and at its bottom section—which is optionally provided with a reinforcement—it cooperates at least partially in a positive manner with the counter element B. On the base plate 303—preferably to the side of a flank of the receptacle 305—is arranged a first bearing pin 309 which projects parallel to the counter element B from the base plate 303, to which in the present case it is attached. Where any directional details are given below using cylindrical coordinates, this cylindrical coordinate system is defined by the first bearing pin 309.

A clamping eccentric 311 is mounted on the base plate 303 by means of the first bearing pin 309 and is pivotable in relation thereto, such that its pivoting range is arranged parallel to the base plate 303 and passes over the receptacle 305. The clamping eccentric 311 is pretensioned, by means of a spring (not shown here) that is supported on the base plate 303, against the counter element B located in the receptacle 305. The clamping surface 315 of the clamping eccentric 311 bears against the counter element B and is curved eccentrically to the first bearing pin 309, so that the counter element B is forced into the receptacle 305 and is thus secured in the normal case. Radially arranged between the clamping surface 315 and the first bearing pin 309, the clamping eccentric 311 has a slot 318 curved around the first bearing pin 309.

An intercepting component 321 is also mounted pivotably relative to the base plate 303 by means of the first bearing pin 309, specifically it is mounted axially relative to the first bearing pin 309 between the clamping eccentric 311 and the base plate 303 in a plane parallel to the latter, and its pivoting range also passes over the receptacle 305. A pin 322 projecting axially from the intercepting component 321 relative to the bearing pin 309 engages in the slot 318, thereby creating a slot-and-pin guide for coupling and mutual driving engagement of the clamping eccentric 311 and the intercepting component 321. The intercepting component 321 may be pretensioned in the same direction as the clamping eccentric 311. The intercepting component 321 has an intercepting surface 325 that is arranged tangentially or concentrically to the first bearing pin 309, i.e. in the present case it is curved around the latter. In the event of a crash, the intercepting surface 325 comes to bear against the counter element B, and—due to the fact that the intercepting surface 325 is concentric to the first bearing pin 309—the counter element B cannot exert any opening force on the intercepting component 321. As a result, by means of the intercepting surface 325, the intercepting component 321 supports the counter element B so that the latter remains in the receptacle 305, even if the counter element B exerts an opening force on the clamping eccentric 311.

A second bearing pin 329 by means of which a blocking element 335 is pivotably mounted on the base plate 303 is arranged parallel to the first bearing pin 309. The blocking element 335 is arranged—at least partially—in the same plane as the intercepting component 321 and is pretensioned towards the receptacle 305 by means of a spring that is not shown here. The pivoting range of the blocking element 335 also passes over the receptacle 305. In the locked state of the locking device 301, however, the counter element B keeps the blocking element 335 pushed to one side, i.e. to the side of the receptacle 305.

To make the transition into the unlocked state of the locking device 301, the intercepting component 321 is pivoted open, for example by means of a Bowden cable acting on and attached to the intercepting component 321. The clamping eccentric 311 is taken along by means of the slot-and-pin guide. The counter element B can now leave the receptacle 305. The locking device 301 is then in the unlocked state. The spring loading of the blocking element 335 brings the latter into a position where it crosses at least partially over the receptacle 305, i.e. over the direction of insertion, i.e. a blocking element's 335 direction being radial relative to the second bearing pin 329 runs transverse to the direction of insertion of the counter element B into the receptacle 305, and a stop may be provided to limit the travel of the blocking element 335.

By means of a suitable offset 337 or similar provided in the vicinity of the point of contact with the counter element B during the locking process, the blocking element 335 cooperates with the intercepting component 321, preferably by positive engagement, namely at a corner or similar of the intercepting surface 325, and it directly holds the intercepting component 321 open. The clamping eccentric 311 is also indirectly held open by means of the slot-and-pin guide. Thus the blocking element 335 prevents the locking device 301 from becoming locked without the counter element B, i.e. it prevents the components from occupying a position corresponding to the locked state. This held-open state can be made visible from the outside by providing a marking on a visible surface or similar, for example on the intercepting component 321.

If the counter element B is re-inserted into the receptacle 305 in the direction of insertion, the counter element B pushes the blocking element 335 back and as a result the latter releases the intercepting component 321. The two securing elements, i.e. the intercepting component 321 and the clamping eccentric 311, can pivot again towards the receptacle 305 and become effective again, when the counter element B comes to bear against the bottom of the receptacle 305.

In a modification of the fourth exemplary embodiment the only differences that exist are to be found in the shape of the blocking element 335, the distance between the shoulder 337 and the point of contact with the counter element B during the locking process, and the point where the shoulder 337 cooperates with the intercepting component 321. In the modification, the shoulder 337 is provided on a longitudinal extension of the blocking element 335 in order to cooperate with the intercepting component 321 at a point located at a distance from the intercepting surface 325, in the present case also at a corner.

Instead of the intercepting component 321, the blocking element 335 could also directly hold the clamping eccentric 311 open in the unlocked state, and said clamping eccentric would then hold the intercepting component 321 open by means of the slot-and-pin guide, i.e. the blocking element 335 would indirectly hold the intercepting component 321 open.

In modified versions of the first three exemplary embodiments and their modifications a blocking element 335 can also be provided which, in the unlocked state, indirectly or directly holds open the clamping eccentrics and/or intercepting components that are present.

While specific embodiments of the invention have been shown and described in detail to illustrate the application of the principles of the invention, it will be understood that the invention may be embodied otherwise without departing from such principles.

1. A vehicle component locking device, for cooperating with a counter element the locking device comprising:
a base plate;
a bearing pin;
a clamping eccentric pivotably mounted on the base plate by means of said bearing pin, the clamping eccentric being normally pretensioned to secure the counter element; and
an intercepting component pivotably mounted relative to the base plate the intercepting component supporting the counter element in the event of a vehicle crash, the clamping eccentric and the intercepting component acting directly on the counter element as securing elements in the locked state of the locking device.

2. A vehicle component locking device according to claim 1, wherein the base plate has a receptacle which in its bottom section cooperates positively with the counter element when the locking device is in the locked state, said bottom section including a reinforcement in said bottom section.

3. A vehicle component locking device according to claim 1, wherein the clamping eccentric includes a clamping surface and in the locked state of the locking device the clamping eccentric normally bears directly against the counter element by means of said clamping surface that is eccentrically curved relative to the bearing pin.

4. A vehicle component locking device according to claim 1, wherein in order to unlock the locking device, the intercepting component has an unlocking pin or another element attached thereto, by means of which the intercepting component can be pivoted away from the counter element, and which takes the clamping eccentric along against the pretensioning of the latter.

5. A vehicle component locking device according to claim 1, wherein the intercepting component is pivotably mounted on the base plate by means of the bearing pin.

6. A vehicle component locking device according to claim 5, wherein in the locked state of the locking device the intercepting component directly supports the counter element in the event of a crash by means of an intercepting surface arranged tangentially or concentrically with regard to the bearing pin.

7. A vehicle component locking device according to claim 1, further comprising at least one of a second clamping eccentric and a second intercepting component for acting on the counter element in a manner similar to the first clamping eccentric and to the first intercepting component.

8. A vehicle component locking device according to claim 7, wherein the first clamping eccentric and the first intercepting component on the one hand, and the second clamping eccentric and the second intercepting component on the other hand, are configured and arranged in mirror-inverted symmetry to one another with reference to a plane, the latter being defined by the direction of insertion of the counter element into the receptacle and by the line normal to the base plate.

9. A vehicle component locking device according to claim 7, further comprising another bearing pin connected to the base plate wherein the at least one of a second clamping eccentric and second intercepting component are mounted on the another bearing pin and the securing elements arranged on the bearing pin are pretensioned and/or pivot in opposite directions to securing elements arranged on the another bearing pin.

10. A vehicle component locking device according to claim 1, wherein the securing elements are arranged on the bearing pin are pretensioned and/or pivot in the same direction and/or are coupled by coupling means including a slot-and-pin guide to bring about driving engagement.

11. A vehicle component locking device according to claim 9, wherein the provided securing elements are acted on by first and second springs that are supported on the base plate and are coiled around the assigned first and second bearing pins.

12. A vehicle component locking device according to claim 1, further comprising a blocking element for, in the unlocked state of the locking device, indirectly or directly holding open at least one securing element.

13. A vehicle component locking device according to claim 12, wherein the blocking element directly holds open exactly one securing element and indirectly holds open the other securing elements.

14. A vehicle component locking device according to claim 12, wherein the blocking element cooperates positively with the securing element that is to be held open, and has a shoulder for cooperating with a corner of the securing element.

15. A vehicle component locking device according to claim 12, wherein:
the base plate has a receptacle cooperating positively with the counter element; and
in the unlocked state of the locking device, the blocking element crosses the receptacle transversely to the direction in which the counter element is inserted into the receptacle.

16. A vehicle component locking device according to claim 1, wherein the locking device is mounted on one of two components of the vehicle, and the counter element is mounted on the other component, so that in the locked state both components are joined together by the cooperation of the locking device with the counter element, and in the unlocked state they are moveable relative to each other and/or can be moved away from each other.

17. A vehicle component locking device according to claim 1, further comprising another bearing pin connected to the base plate, wherein the intercepting component is pivotably mounted on the base plate by means of the second bearing pin.

18. A locking arrangement for locking a first vehicle component to a second vehicle component, the locking arrangement comprising:
a counter element connected to the first component;
a base plate connected to the second component, said base plate having a receptacle portion receiving said counter element;
a bearing pin connected to said base plate;
a clamping eccentric pivotably mounted on the base plate via said bearing pin, said clamping eccentric being pretensioned to secure the counter element in said receptacle in a locking state; and
an intercepting component pivotably mounted relative to said base plate, said intercepting component supporting the counter element in the event of a vehicle crash the clamping eccentric and the intercepting component directly contacting and acting on the counter element as securing elements in the locked state.

19. A locking arrangement according to claim 18, wherein the clamping eccentric includes a clamping surface eccentrically curved relative to said bearing pin wherein in the locked state said clamping surface bears directly against the counter element.

20. A locking arrangement according to claim 19, wherein said intercepting component is mounted on said bearing pin and includes an intercepting surface arranged tangentially or concentrically with respect to said bearing pin.
